(19) United States
(12) Patent Application Publication
(10) Pub. No.: US 2020/0184271 A1
(43) Pub. Date: Jun. 11, 2020

(54) ITERATIVE DATA PATTERN PROCESSING ENGINE LEVERAGING DEEP LEARNING TECHNOLOGY

(71) Applicant: BANK OF AMERICA CORPORATION, Charlotte, NC (US)

(72) Inventors: Eren Kursun, New York, NY (US); Craig D. Widmann, Chandler, AZ (US)

(73) Assignee: BANK OF AMERICA CORPORATION, Charlotte, NC (US)

(21) Appl. No.: 16/210,125

(22) Filed: Dec. 5, 2018

(51) Int. Cl. G06K 9/62; G06N 3/08

(52) U.S. Cl. CPC G06K 9/6262; G06N 3/08

(57) ABSTRACT

An artificial intelligence system and method leveraging deep learning technology for data pattern processing and identifying misappropriation are provided herein comprising a deep learning engine comprising a data patterning component and a reasoning component. A controller is configured to: monitor a data stream comprising user interaction data; extract the interaction data from the data stream; determine, using the data patterning component, a data pattern from the extracted interaction data, wherein the data pattern is output to the reasoning component; analyze, using the reasoning component, the data pattern by comparing the data pattern to predetermined rules and factual reference data; identify an anomaly in the data pattern based on comparing the data pattern, wherein the anomaly is associated with misappropriation resources; in response, generate a revised data pattern, wherein the revised data pattern is output to the data patterning component; and confirm the revised data pattern using the data patterning component.

### BACKGROUND

Modern data security and misappropriation investigation systems are highly manual, requiring large amounts of time and assets to recover sometimes insignificant resource amounts from potential misappropriation. Furthermore, current techniques can be inaccurate due to the dependence on blanket decisions or limited data for decision making which can impact the quality of the results. What is more, other analytical techniques used in misappropriation prevention and detection are directly affected by the results, as they can rely on this data for strategizing. Therefore, there exists a need for an improved data patterning technique which may be applied to, for example, misappropriation identification processing.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method and computer program product for leveraging deep learning technology for data pattern processing and identifying misappropriation. In one embodiment, an artificial intelligence system is provided comprising: a deep learning engine comprising a data patterning component and a reasoning component; and a controller configured for monitoring interaction data, the controller comprising at least one memory device with computer-readable program code stored thereon, at least one communication device connected to a network, and at least one processing device, wherein the at least one processing device is configured to execute the computer-readable program code to: monitor a data stream, wherein the data stream comprises interaction data associated with a user; extract the interaction data associated with the user from the data stream; determine, using the data patterning component of the deep learning engine, a data pattern from the extracted interaction data, wherein the data pattern is output to the reasoning component of the deep learning engine; analyze, using the reasoning component, the data pattern by comparing the data pattern to predetermined rules and factual reference data; identify an anomaly in the data pattern based on comparing the data pattern, wherein the anomaly is associated with potential misappropriation of user resources; in response to identifying the anomaly, generate a revised data pattern, wherein the revised data pattern is output to the data patterning component; and confirm the revised data pattern using the data patterning component.

In one embodiment, the revised data pattern is a first revised pattern, and wherein the at least one processing device is further configured to revise, using the data patterning component, the first revised pattern thereby generating a second revised pattern.

In one embodiment, the at least one processing device is further configured to execute an iterative revision process, wherein the data patterning component and the reasoning component of the deep learning engine iteratively revise the data pattern.

In one embodiment, the at least one processing device is further configured to continue the iterative revision process until an output of the data patterning component and an output of the reasoning component converge on a result.

In one embodiment, the output of the data patterning component and the output of the reasoning component converging on the result comprises the output of the data patterning component and the output of the reasoning component being the same.

In one embodiment, the output of the data patterning component and the output of the reasoning component converging on the result comprises the controller determining that a similarity between the output of the data patterning component and the output of the reasoning component is within a predetermined threshold.

In one embodiment, the at least one processing device is further configured to terminate the iterative revision process in response to an output of the data patterning component and an output of the reasoning component not converging on a result.

In one embodiment, the at least one processing device is further configured to terminate the iterative revision process after a predetermined number of cycles of the iterative revision process, wherein the output of the data patterning component and the output of the reasoning component do not converge during the predetermined number of cycles.

In one embodiment, the predetermined rules and factual reference data of the reasoning component of the deep learning engine comprise a data ontology database.

In one embodiment, determining the data pattern from the extracted interaction data using the data patterning component of the deep learning engine further comprises generating a user profile based on historical interaction data.

In one embodiment, the interaction data comprises at least one interaction between a client and an entity, and wherein generating the user profile based on the historical interaction data further comprises generating a client profile associated with the client and an entity profile associated with the entity.

In one embodiment, a data security scoring engine is further provided, wherein the at least one processing device is further configured to calculate a data security score for the data pattern, wherein the data security score represents a calculated probability for potential misappropriation associated with the data pattern based on historical interaction data and known misappropriation patterns.

An artificial intelligence system leveraging deep learning technology for iterative data pattern processing is also provided. The system comprises: a deep learning engine comprising a data patterning component and a reasoning component; and a controller configured for monitoring a data stream, the controller comprising at least one memory device with computer-readable program code stored thereon, at least one communication device connected to a network, and at least one processing device, wherein the at least one processing device is configured to execute the computer-readable program code to: determine, using the data patterning component of the deep learning engine, a data pattern of the data stream; analyze, using the reasoning component, the data pattern by comparing the data pattern to predetermined rules and factual reference data; iteratively revise the data pattern to generate at least one revised data pattern using the data patterning component and the reasoning component, wherein the at least one revised data pattern output from either one of the data patterning component and the output of the reasoning component is subsequently input into the other; determine that an output of the data patterning component and an output of the reasoning component converge on a final data pattern; and in response to determining that the output of the data patterning component and the output of the reasoning component converge, confirm the final data pattern.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides an iterative data patterning and reasoning system environment, in accordance with one embodiment of the invention;

FIG. 2 provides a block diagram of a user device, in accordance with one embodiment of the invention;

FIG. 3 provides a block diagram of an iterative data patterning and reasoning system, in accordance with one embodiment of the invention;

FIG. 4 provides a high level process map for iterative data patterning, exposure scoring, and reasoning, in accordance with one embodiment of the invention; and

FIG. 5 provides a high level process flow for iterative data patterning, exposure scoring, and reasoning, in accordance with one embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Embodiments of the system, as described herein leverage artificial intelligence, machine-learning, neural networks, and/or other complex, specific-use computer systems to provide a novel approach for iterative data patterning. In a specific implementation, deep learning systems may be used to analyze complex interactions in real time in order to identify, process, and rectify potential misappropriation. Modern misappropriation investigation systems are highly manual, requiring large amounts of time and assets to recover sometimes insignificant amounts of resources from potential misappropriation. Furthermore, current techniques can be inaccurate due to the dependence on blanket decisions or limited data for decision making which can impact the quality of the results. What is more, other analytical techniques used in misappropriation prevention and detection are directly affected, as they can rely on this data for further strategizing. Instead, by leveraging deep learning technology and applying a hybrid, iterative reasoning approach in the patterning learning process, the accuracy and efficiency of patterning relied on by decisioning processes, such as misappropriation analysis, can be improved. Implementing a two-step, iterative feedback analysis loop allows for a process that is able to refine results between patterning and reasoning components of a deep learning engine until a final result may be confirmed. As such, the present invention not only provides a technical improvement to misappropriation identification and processing, but also patterning techniques leveraging deep learning technology.

As used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), a mobile Internet accessing device, or other mobile device. Other types of mobile devices may include laptop computers, tablet computers, wearable devices, cameras, video recorders, audio/video player, radio, global positioning system (GPS) devices, portable digital assistants (PDAs), pagers, mobile televisions, gaming devices, or any combination of the aforementioned. The device may be used by the user to access the system directly or through an application, online portal, internet browser, virtual private network, or other connection channel.

As used herein, the term “computing resource” may refer to elements of one or more computing devices, networks, or the like available to be used in the execution of tasks or processes. A computing resource may be used to refer to available processing, memory, and/or network bandwidth and/or power of an individual computing device as well a plurality of computing devices that may operate as a collective for the execution of one or more tasks (e.g., one or more computing devices operating in unison). In some embodiments, a “resource” may refer to a monetary resource or currency in any form such as cash, check, credit, debit, reward points, or the like.

As used herein, the term “user” may refer to any entity or individual associated with the iterative pattern learning and reasoning system. In some embodiments, a user may be a computing device user, a phone user, a mobile device application user, a customer of an entity or business, a financial institution customer (e.g., an account holder or a person who has an account (e.g., banking account, credit account, or the like)), a system operator, a customer service representative, and/or employee of an entity. In a specific embodiment, a user may be a customer accessing a user account via an associated user device. In another specific embodiment, the user is a victim of potential unauthorized system and/or account access or misappropriation by another individual. In some embodiments, identities of an individual may include online handles, usernames, identification numbers (e.g., Internet protocol (IP) addresses), aliases, family names, maiden names, nicknames, or the like. In some embodiments, the user may be an individual or an organization (i.e., a charity, business, company, governing body, or the like).

As used herein, the term “entity” may be used to include any organization or collection of users that may interact with the iterative pattern learning and reasoning system. An entity may refer to a business, company, or other organization that either maintains or operates the system or requests use and accesses the system. The terms “financial institution” and “financial entity” may be used to include any organization that processes financial transactions including, but not limited to, banks, credit unions, savings and loan associations, investment companies, stock brokerages, asset management firms, insurance companies and the like. In specific embodiments of the invention, use of the term “bank” is limited to a financial entity in which account-bearing customers conduct financial transactions, such as account deposits, withdrawals, transfers and the like. In other embodiments, an entity may be a business, organization, a government organization or the like that is not a financial institution. In one embodiment, the entity may be a software development entity or data management entity. In a specific embodiment, the entity may be a cybersecurity entity or misappropriation prevention entity. In some embodiments, an entity may refer to a third party entity separate from the user and/or another entity. In one embodiment, a third party entity or third party may refer to a merchant or any other entity interacting with but not maintaining the system described herein.

As used herein, “authentication information” may refer to any information that can be used to identify a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to at least partially authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system.

To “monitor” is to watch, observe, or check something for a special purpose over a period of time. The “monitoring” may occur periodically over the period of time, or the monitoring may occur continuously over the period of time. In some embodiments, a system may actively monitor a data source, database, or data archive, wherein the system reaches out to the database and watches, observes, or checks the database for changes, updates, and the like. In other embodiments, a system may passively monitor a database, wherein the database provides information to the system and the system then watches, observes, or checks the provided information. In some embodiments a system, application, and/or module may monitor a user input in the system. In further embodiments, the system may store said user input during an interaction in order to generate a user interaction profile that characterizes regular, common, or repeated interactions of the user with the system. In some embodiments, “monitoring” may further comprise analyzing or performing a process on something such as a data source either passively or in response to an action or change in the data source.

As used herein, an “interaction” may refer to any action or communication between one or more users, one or more entities or institutions, and/or one or more devices or systems within the system environment described herein. For example, an interaction may refer to a user interaction with a system or device, wherein the user interacts with the system or device in a particular way. An interaction may include user interactions with a user interface (e.g., clicking, swiping, text or data entry, etc.), authentication actions (e.g., signing-in, username and password entry, PIN entry, etc.), account actions (e.g., account access, fund transfers, etc.) and the like. In another example, an interaction may refer to a user communication via one or more channels (i.e., phone, email, text, instant messaging, brick-and-mortar interaction, and the like) with an entity and/or entity system to complete an operation or perform an action with an account associated with user and/or the entity. In some embodiments, as discussed herein, a user interaction may include a user communication which may be analyzed using natural language processing techniques or the like. In some embodiments, an interaction may refer to a financial transaction.

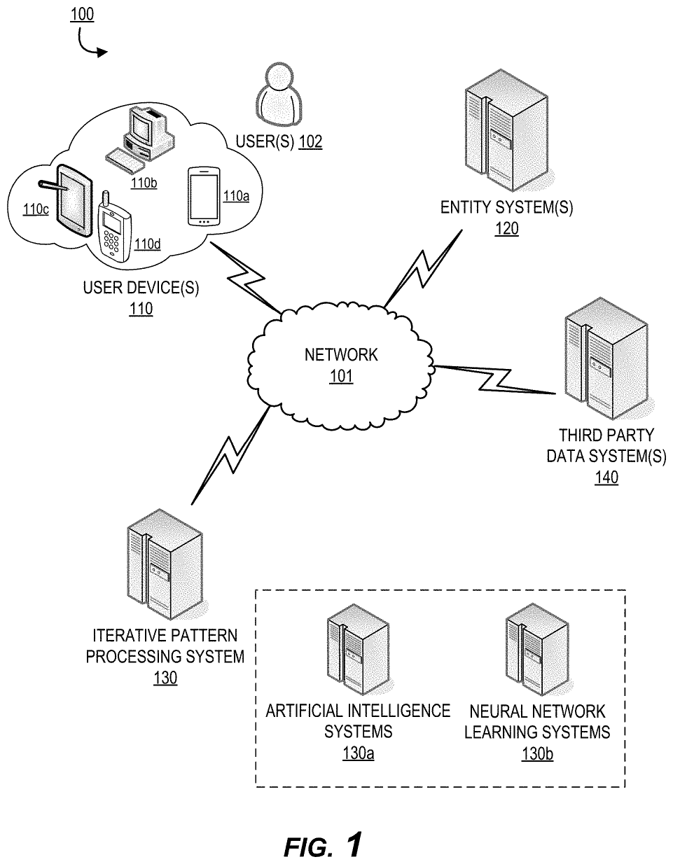

FIG. 1 provides an iterative data patterning and reasoning system environment 100, in accordance with one embodiment of the invention. In a specific embodiment described herein, the iterative data patterning and reasoning system 100 is configured for processing potential misappropriation reports to reduce exposure (i.e., risk) for an entity (e.g., a financial entity). As illustrated in FIG. 1, the iterative data patterning and reasoning system 130 is operatively coupled, via a network 101, to the user device(s) 110 (e.g., a plurality of user devices 110a-110d), the entity system 120, and the third party data systems 140. In this way, the iterative data patterning and reasoning system 130 can send information to and receive information from the user device 110, the entity system 120, and the third party data system 140. In the illustrated embodiment, the plurality of user devices 110a-110d provide a plurality of communication channels through which the entity system 120 and/or the iterative data patterning and reasoning system 130 may communicate with the user 102 over the network 101.

In the illustrated embodiment, the iterative data patterning and reasoning system 130 further comprises an artificial intelligence (AI) system 130a and a neural network learning system 130b which may be separate systems operating together with the iterative data patterning and reasoning system 130 or integrated within the iterative data patterning and reasoning system 130.

FIG. 1 illustrates only one example of an embodiment of the system environment 100. It will be appreciated that in other embodiments, one or more of the systems, devices, or servers may be combined into a single system, device, or server, or be made up of multiple systems, devices, or servers. It should be understood that the servers, systems, and devices described herein illustrate one embodiment of the invention. It is further understood that one or more of the servers, systems, and devices can be combined in other embodiments and still function in the same or similar way as the embodiments described herein.

The network 101 may be a system specific distributive network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101.

In some embodiments, the user 102 is an individual interacting with the entity system 120 via a user device 110 while a data flow between the user device 110 and the entity system 120 is monitored by the iterative data patterning and reasoning system 130 over the network 101. In some embodiments a user 102 is a user requesting service from the entity (e.g., customer service) or interacting with an account maintained by the entity system 120. In an alternative embodiment, the user 102 is an unauthorized user attempting to gain access to a user account of an actual, authorized user (i.e., misappropriation).

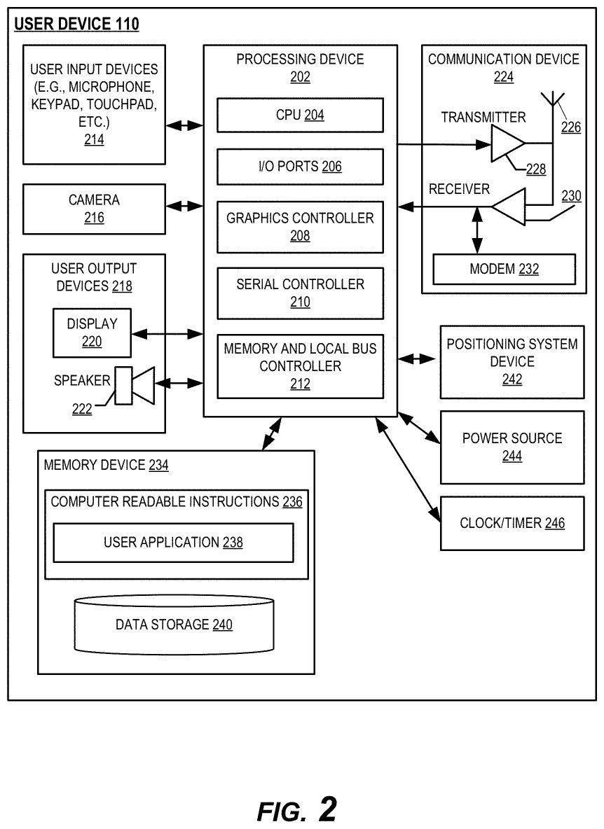

FIG. 2 provides a block diagram of a user device 110, in accordance with one embodiment of the invention. The user device 110 may generally include a processing device or processor 202 communicably coupled to devices such as, a memory device 234, user output devices 218 (for example, a user display device 220, or a speaker 222), user input devices 214 (such as a microphone, keypad, touchpad, touch screen, and the like), a communication device or network interface device 224, a power source 244, a clock or other timer 246, a visual capture device such as a camera 216, a positioning system device 242, such as a geo-positioning system device like a GPS device, an accelerometer, and the like. The processing device 202 may further include a central processing unit 204, input/output (I/O) port controllers 206, a graphics controller or graphics processing device (GPU) 208, a serial bus controller 210 and a memory and local bus controller 212.

The processing device 202 may include functionality to operate one or more software programs or applications, which may be stored in the memory device 234. For example, the processing device 202 may be capable of operating applications such as the user application 238. The user application 238 may then allow the user device 110 to transmit and receive data and instructions from the other devices and systems of the environment 100. The user device 110 comprises computer-readable instructions 236 and data storage 240 stored in the memory device 234, which in one embodiment includes the computer-readable instructions 236 of a user application 238. In some embodiments, the user application 238 allows a user 102 to access and/or interact with other systems such as the entity system 120. In some embodiments, the user is a customer of a financial entity and the user application 238 is an online banking application providing access to the entity system 120 wherein the user may interact with a user account via a user interface of the user application 238.

The processing device 202 may be configured to use the communication device 224 to communicate with one or more other devices on a network 101 such as, but not limited to the entity system 120 and the iterative data patterning and reasoning system 130. In this regard, the communication device 224 may include an antenna 226 operatively coupled to a transmitter 228 and a receiver 230 (together a “transceiver”), modem 232. The processing device 202 may be configured to provide signals to and receive signals from the transmitter 228 and receiver 230, respectively. The signals may include signaling information in accordance with the air interface standard of the applicable BLE standard, cellular system of the wireless telephone network and the like, that may be part of the network 201. In this regard, the user device 110 may be configured to operate with one or more air interface standards, communication protocols, modulation types, and access types. By way of illustration, the user device 110 may be configured to operate in accordance with any of a number of first, second, third, and/or fourth-generation communication protocols and/or the like. For example, the user device 110 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user device 110 may also be configured to operate in accordance with non-cellular communication mechanisms, such as via a wireless local area network (WLAN) or other communication/data networks. The user device 110 may also be configured to operate in accordance Bluetooth® low energy, audio frequency, ultrasound frequency, or other communication/data networks.

The user device 110 may also include a memory buffer, cache memory or temporary memory device operatively coupled to the processing device 202. Typically, one or more applications 238, are loaded into the temporarily memory during use. As used herein, memory may include any computer readable medium configured to store data, code, or other information. The memory device 234 may include volatile memory, such as volatile Random Access Memory (RAM) including a cache area for the temporary storage of data. The memory device 234 may also include non-volatile memory, which can be embedded and/or may be removable. The non-volatile memory may additionally or alternatively include an electrically erasable programmable read-only memory (EEPROM), flash memory or the like.

Though not shown in detail, the system further includes one or more entity systems 120 and third party data systems (associated with third party entities (e.g., merchants)), as illustrated in FIG. 1, which are configured to be connected to the user device 110 and the iterative data patterning and reasoning system 130 and which may be associated with one or more entities, institutions or the like. In this way, while only one entity system 120 (or third party data system) is illustrated in FIG. 1, it is understood that multiple networked systems may make up the system environment 100. The entity system 120 generally comprises a communication device, a processing device, and a memory device. The entity system 120 comprises computer-readable instructions stored in the memory device, which in one embodiment includes the computer-readable instructions of an entity application. The entity system 120 may communicate with the user device 110 and the iterative data patterning and reasoning system 130 to provide access to one or more user accounts stored and maintained on the entity system 120. In some embodiments, the entity system 120 may communicate with the iterative data patterning and reasoning system 130 during an interaction with a user 102 in real-time, wherein user interactions may be monitored and processed by the iterative data patterning and reasoning system 130 in order to analyze interactions with the user 102 and reconfigure a neural network architecture in response to changes in a received or monitored data stream.

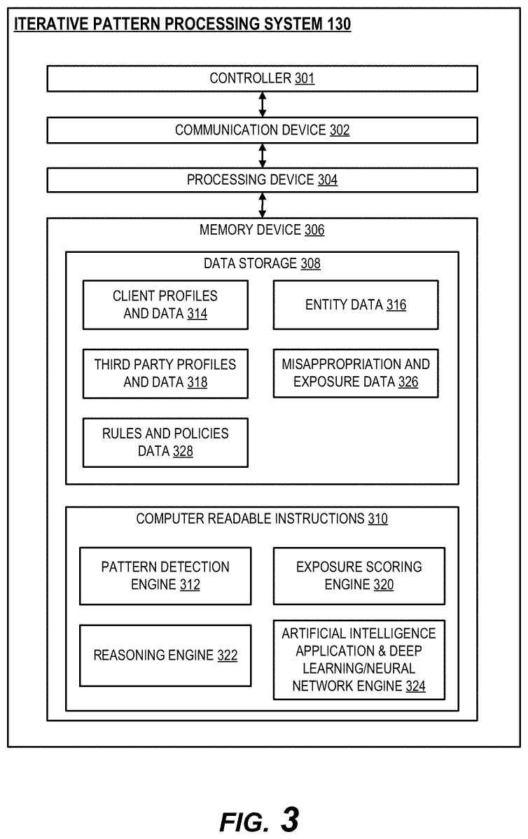

FIG. 3 provides a block diagram of an iterative data patterning and reasoning system 130, in accordance with one embodiment of the invention. The iterative data patterning and reasoning system 130 generally comprises a controller 301, a communication device 302, a processing device 304, and a memory device 306.

As used herein, the term “controller” generally refers to a hardware device and/or software program that controls and manages the various systems described herein such as the user device 110, the entity system 120, and/or the iterative data patterning and reasoning system 130, in order to interface and manage data flow between systems while executing commands to control the systems. In some embodiments, the controller may be integrated into one or more of the systems described herein. In some embodiments, the controller may perform one or more of the processes, actions, or commands described herein.

As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 304 is operatively coupled to the communication device 302 and the memory device 306. The processing device 304 uses the communication device 302 to communicate with the network 101 and other devices on the network 101, such as, but not limited to the user device 110 and the entity system 120. As such, the communication device 302 generally comprises a modem, server, or other device for communicating with other devices on the network 101.

As further illustrated in FIG. 3, the iterative data patterning and reasoning system 130 comprises computer-readable instructions 310 stored in the memory device 306, which in one embodiment includes the computer-readable instructions 310 of a pattern detection engine 312, an exposure scoring engine 320, a reasoning engine 322, and an artificial intelligence application 324 which further comprises a deep learning/neural network engine. In one embodiment, the artificial intelligence application 322 and deep learning/neural network engine may be utilized by, for example, the reasoning engine 322 and/or pattern detection engine 312 to analyze user interactions via generated patterns and identify potential misappropriation.

In some embodiments, the memory device 306 includes data storage 308 for storing data related to the system environment, but not limited to data created and/or used by the pattern detection engine 312, exposure scoring engine 320, reasoning engine 322, and the artificial intelligence application 322, and a deep learning/neural network engine. This created and/or used data may include client profiles and data 314, entity data 315, third party profiles and data 318, misappropriation and exposure data 326, and rules and policies data 328.

In some embodiments, the client profiles and data 314 comprises information and data associated with one or more users, clients, customers, or the like associated with an entity (e.g., account holders at a financial institution). For example, the client profiles and data 314 may include but is not limited to interaction data (e.g., transaction history), interaction parameters (e.g., interaction channels, resource amounts, interaction locations, interaction scheduling, etc.), authentication history and patterns, and entity interaction history and patterns (i.e., client interactions with the entity). In some embodiments, the client profiles and data 314 may further comprise stored historical interaction data associated with clients as well as non-resource events (e.g., account information changes, profile information updates).

In some embodiments, the third party profiles and data 318 comprise information and data associated with one or more third party entities, external entities, merchants, or the like that may be associated with one or more interactions analyzed by the system described herein. For example, the third party entity may be a merchant that completed a transaction with a client of a financial institution, wherein the transaction is being investigated for potential misappropriation. In some embodiments, the third party profiles and data 318 may include but is not limited to information associated with interaction volumes, times, user base (i.e., customers), interaction parameters (e.g., types of interaction devices used by the third party (e.g., point-of-sale devices, chip card capabilities, contactless payment capabilities, etc.)), and the like. In one embodiment, the third party profiles and data 318 may include information associated with other external entities or devices such as other financial entities or third party ATMs.

In some embodiments, the entity data 316 comprises information and data associated with an entity such as the entity maintaining the entity system 120 and/or the iterative patterning and reasoning system 130. In one embodiment, the entity data 316 is internal data associated with a financial entity having one or more clients with accounts maintained by the financial entity. In some embodiments, the entity data 316 may comprise the misappropriation and exposure data 326. The misappropriation and exposure data 326 may include but is not limited to misappropriation historical data (e.g., previous investigations, conclusions, and data); recent misappropriation patterns, strategies, and data; exposure scoring thresholds, maps, strategies, data, and the like. In some embodiments, the entity data 316 may further include the rules and policies data 328 which may include but is not limited to information and strategies governing overall decisioning and outlining actions to be performed based on conclusions determined by the system described herein. For example, the rules and policies data 328 may include response strategies or conditions for positively identifying misappropriation and remedying of rectifying exposed resources of a client (e.g., reimbursing lost funds). In other embodiments, the misappropriation and exposure data 326 and/or rules and policies data 328 are separate from the entity data 316. In some embodiments, for example, the misappropriation and exposure data 326 is continuously updated in real-time as interactions are received by the system. In this way, the artificial intelligence and/or deep learning engines may learn from the interactions in real-time to accurately identify misappropriation thereby reducing entity exposure and increasing data security of the entity and clients.

In one embodiment of the invention, the iterative data patterning and reasoning system 130 may associate with applications having computer-executable program code that instructs the processing device 304 to perform certain functions described herein. In one embodiment, the computer-executable program code of an application associated with the user device 110 and/or the entity system 120 may also instruct the processing device 304 to perform certain logic, data processing, and data storing functions of the application. In one embodiment, the iterative data patterning and reasoning system 130 further comprises a deep learning algorithm to be executed by the processing device 304 or a controller configured to receive and analyze interaction data and identify misappropriation within the interaction data.

Embodiments of the iterative data patterning and reasoning system 130 may include multiple systems, servers, computers or the like maintained by one or many entities. In some embodiments, the iterative data patterning and reasoning system 130 may be part of the entity system 120. In other embodiments, the entity system 120 is distinct from the interaction monitoring system 130. The iterative data patterning and reasoning system 130 may communicate with the entity system 120 and/or the other devices and systems of environment 100 via a secure connection generated for secure encrypted communications between the two systems either over the network 101 or alternative to the network 101.

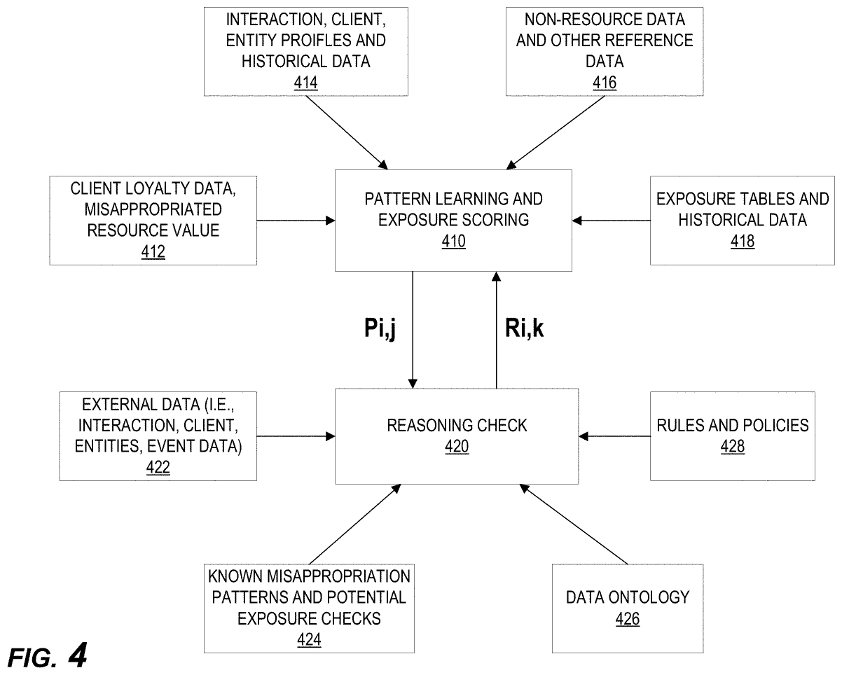

FIG. 4 provides a high level process map for iterative data patterning, exposure scoring, and reasoning, in accordance with one embodiment of the invention. The system, such as the data patterning and reasoning system 130, is configured to monitor a data stream received by the system. In some embodiments, interactions performed between the user device(s) 110 and the entity system 120 are intercepted and monitored by the data patterning and reasoning system 130, wherein user interaction data may be extracted from an interaction over the network 101 by the data patterning and reasoning system 130 to identify and remedy potential misappropriation. In some embodiments, a data stream may be monitored by a deep learning engine having a data patterning component and a reasoning component. The data patterning component may be configured to determine one or more data patterns in the monitored data stream. The reasoning component may be configured to receive an output of the data patterning component and further analyze the one or more data patterns by comparing the data pattern to a number of data source such as predetermined rules, policies, historical data (e.g., interaction and known misappropriation data), factual reference data (i.e., for determining logical data connections), and the like.

Data monitored and/or extracted by the system may include, in a non-limiting example, user identifying information, communication history, interaction or transaction information, and the like. Data, such as user interaction data, may be acquired from across communication channels of an entity such as phone lines, text messaging systems, email, applications (e.g., mobile applications), websites, ATMs, card readers, call centers, electronic assistants, instant messaging systems, interactive voice response (IVR) systems, brick-and-mortar locations and the like. In some embodiments, data is continuously monitored and/or collected in real-time as interactions occur. In this way, the system may leverage artificial intelligence and deep learning technology to learn from the monitored interaction data to more accurately positively identify and remedy misappropriation.

In some embodiments, interaction data is received by the system or submitted to the system through various channels including, but not limited to, alerts generated during interaction processing by a processing entity (e.g., a financial entity processing the interaction), requests transmitted by a client or user (i.e., reported potential misappropriation or a request to investigate potential misappropriation), and/or requests submitted by an entity during interaction post-processing (e.g., an entity investigating previously identified misappropriation). In some embodiments, the system may be configured to continuously monitor a data stream and determine data patterns from the data including patterns of misappropriation. In some embodiments, the system receives interaction data through the communication channels that is tagged as being associated with potential misappropriation, wherein the tagged misappropriation data is input into the system for further analysis and confirmation of the suspected misappropriation by the components of the deep learning engine.

Data, such as the previously discussed interaction data, is received by the system (e.g., data patterning and reasoning system 130) through a data stream transmitted over a network (e.g., network 101). As previously discussed, the data stream may include both previously known historical data as well as new data received and processed by the system in real-time. The data may be data collected and analyzed by the system and used for pattern learning and decisioning. In some embodiments, the historical data includes predetermined training data used to at least initially pre-train the system with representative data for a desired output. In some embodiments, the system may utilize real-time data and historical data either alone or in combination with one another for learning and decisioning.

Non-limiting examples of data monitored within the data stream include information regarding past, current, or scheduled interactions or transactions associated with the user. Interaction information may include transaction amounts, payor and/or payee information, transaction dates and times, transaction locations, transaction frequencies, and the like. In some embodiments, data may include information regarding account usage. For example, the data stream may include information regarding usage of a credit or debit card account such as locations or time periods where the card was used. In another example, the data may further include merchants with whom the user frequently interacts. In other non-limiting embodiments, the data stream includes non-financial data such as system hardware information (e.g., serial numbers) or other non-financial authentication information data.

The process flow environment of FIG. 4 generally comprises at least a pattern learning and exposure scoring process 410 and a reasoning check process 420. In some embodiments, the pattern earning and exposure scoring process 410 may be executed by the pattern detection engine 312 and/or the exposure scoring engine 320 of the data patterning and reasoning system 130 as shown in the previous system environment. In some embodiments the reasoning check process 420 may be executed by the reasoning engine 322 of the data patterning and reasoning system 130. In some embodiments, the pattern learning and exposure scoring process 410 and the reasoning check process 420 may leverage an artificial intelligence application and deep learning/neural network engine, such as engine 324 of system 130, to perform the processes described herein.

As illustrated in FIG. 4, the pattern learning and exposure scoring process 410 and the reasoning check process 420 (i.e., the components of the deep learning engine) form an interactive hybrid approach to data patterning and, in a specific embodiment, misappropriation identification, wherein the data patterning and exposure scoring process 410 may be improved and refined by the reasoning check process 420. In a specific example, the pattern learning and exposure scoring process 410 identifies data patterns in the received interaction data associated with potential misappropriation. In response, the reasoning check process 420 receives an output of the identified data pattern and may analyze the data pattern to identify one or more anomalies associated with the potential misappropriation. The reasoning check process 420 analyzes the received data pattern and further refines a hypothesis of the pattern learning and exposure scoring process 410. In some embodiments, the interaction between the pattern learning and exposure scoring process 410 and the reasoning check process 420 is iterative, wherein the process 410 and 420 continually output refined data to one another in a loop until both processes converge on a conclusion.

As further illustrated in FIG. 4, the pattern learning and exposure scoring process 410 may receive input data from a variety of data sources such as those data sources stored in data storage 308 of the data pattern and reasoning system 130. As illustrated in blocks 412, 414, 416, and 418, in one embodiment, the pattern learning and exposure scoring process 410 may receive data including, but not limited to, client loyalty data, misappropriated resource values (i.e., misappropriation amounts), interaction data, client data, entity data, third party data, historical data, non-resource data, other reference data (e.g., external data), exposure data and tables, misappropriation patterns and data, historical misappropriation request data, and the like. Client loyalty data may comprise information related to a historical record of a number of past interactions or relationships (e.g., accounts) that a client has or has had with an entity. In some embodiments, client loyalty data may comprise a loyalty level or rank associated with a client, wherein higher loyalty levels are assigned to those clients having a number or past history of interactions and/or relationships with the entity beyond a predetermined threshold. In some embodiments, client loyalty levels may be divided into different tiers, wherein each tier is assigned particular benefits. In some embodiments, actions performed by the decisioning systems described herein may be at least partially based on a client loyalty level of a client associated with analyzed interactions.

In the illustrated embodiment, the reasoning check process 420 may receive input data from a variety of data sources such as those data sources stored in data storage 308 of the data pattern and reasoning system 130. As illustrated in blocks 422, 424, 426, and 428, in one embodiment, the reasoning check process 420 may receive data including, but not limited to, external data from outside the entity (i.e., external interaction data, client data, other entity data, third party data, event data, or the like), known misappropriation patterns and potential exposure checks, data ontology information, and rules and policies.

In some embodiments, data ontology information may comprise organized categorizations and relationships between data, entities, or concepts to define domains around said data, entities, or concepts thereby improving problem solving complexity for particular domains. In some embodiments, artificial intelligence and deep learning engines organize data into domains or hierarchies as the systems learn from received and analyzed data over time. In some embodiments, particular data categories or domains may have associated characteristics, features, or defined responses. For example, within a misappropriation identification process, a system may at least partially use data ontology data to identify an interaction, entity, or user as being associated with misappropriation by matching one or more characteristics of the interaction, entity, or user with the same or similar characteristics of other, previously identified misappropriation interactions within the same domain. Characteristics of an interaction, entity, or user used for categorization include factual data such as, user age, interaction geography, user account balance range, or the like.

As illustrated in FIG. 4, the pattern learning and exposure scoring process 410 outputs a pattern vector, Pi,j, to the reasoning check process 420. In some embodiments, the pattern vector, Pi,j, comprises one or more identified data patterns or anomalies in the received interaction data based on machine deep learning analysis using the data source inputs described above. The vector, Pi,j, may comprise one or more identified events, interactions, entities, users, or the like. In some embodiments, the system further comprises an exposure or data security scoring engine configured to generate custom exposure or data security scores for each event, interaction, entity, user, or the like based on analyzed patterns, profiles, recoverability of the interaction, historical exposure information, and/or additional data input received by the process 410 as illustrated in FIG. 4. In some embodiments, an exposure or data security score represents a calculated probability for potential misappropriation based on historical interaction data and known misappropriation patterns. The system may be configured to compare exposure scores to predetermined thresholds, wherein exposure scores exceeding predetermined thresholds may trigger an alert and or other actions by the system. For example, an exposure score or value being higher than a predetermined threshold may trigger output of data from the pattern learning and exposure scoring process 410 to be used in the iterative feedback loop described herein in order to positively identify or confirm potential misappropriation.

The pattern vector, Pi,j, is output to the reasoning check process 420. In response, the reasoning check process 420 analyzes the received vector based on the data sources available to the reasoning check process 420 as previously described herein to identify anomalies in the received data patterns. In one embodiment, the identified anomalies are interactions associated with potential misappropriation or potential entity exposure. The reasoning check process 420 leverages the artificial intelligence of the system to apply logic, identify anomalies of vector Pi,j, and confirm, refine, or append the machine learning determined results. In some embodiments, the system analyzes the received data by applying rules and policies for identifying and differentiating authorized interactions from unauthorized interactions (e.g., misappropriation). The rules and policies may be defined by an entity maintaining the system. In one embodiment, an unauthorized interaction may be an interaction not permitted by the rules or policies for reasons other than misappropriation. For example, the rules and policies may define that certain interaction types executed on certain devices are not allowed. In some embodiments, the system analyzes the received data by referencing a data ontology database and/or known misappropriation patterns.

By applying the various data sources to the received initial machine learning results (i.e., Pi,j), the reasoning check process 420 may analyze the results to determine logical inconsistencies. In some embodiments, the reasoning check process 420 leverages the artificial intelligence and deep learning engines described here to analyze the data. In a specific example, the system may receive data associated with potential misappropriation and be tasked with determining potential logical inconsistencies in the data contrary to established data patterns, rules, policies, ontological data, or the like of authorized use in order to confirm or reject the potential misappropriation. In the example, the system may flag a change in the data pattern when a user swipes a credit card in-person in New York before the same credit card is detected as being used in-person in Seattle only minutes apart. The system may identify the logical inconsistency of an authorized user being located in the two locations within a short time frame and identify the interaction as misappropriation.

As illustrated in FIG. 4, following the reasoning check process 420, the system generates a new reasoning vector, Ri,k, based on the performed logical analysis. In one embodiment, the system confirms the initial machine learning results provided in vector Pi,j. In some embodiments, the reasoning vector, Ri,k, may be a revised vector, wherein the system refines or appends the machine learning determined results. For example, through application of logical reasoning, the reasoning check 420 may remove one or more of the data entries of the initially provided vector. In another embodiment, the system may add additional data entries to the vector thereby producing a revised vector.

The system sends the reasoning vector, Ri,k, back to the pattern learning and exposure scoring process 410. In some embodiments, the reasoning vector is the same as the pattern vector, wherein the reasoning check process 410 confirms the results of the pattern learning and exposure scoring process 410. In another embodiment, the system generates and sends a revised vector back to the pattern learning and exposure scoring process 410, wherein the revised vector is used as input into the pattern learning and exposure scoring process 410. By using the revised vector as input, the pattern learning and exposure scoring process 410 may be refined, wherein the artificial intelligence and deep learning engines may learn from the revised input. In some embodiments, the feedback between the pattern learning and exposure scoring process 410 and the reasoning check process 420 is iterative, wherein the each of the vectors, Pi,j and Ri,k, may be continually revised and sent between processes 410 and 420 until both vectors converge on a conclusion or final data pattern, that is, both vectors include the same one or more results. In another embodiment, the iterative process may continue for a predetermined number of cycles. In another embodiment, the iterative process may continue until a confidence level of the accuracy of the results is above a predetermined threshold and/or an exposure level or score is below another predetermined threshold.

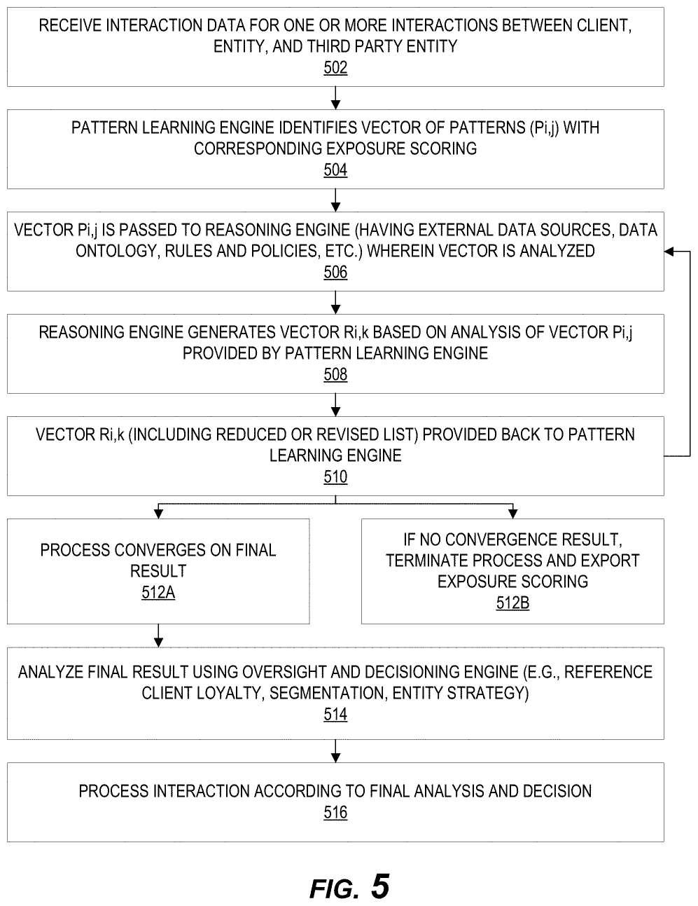

FIG. 5 provides a high level process flow for iterative data patterning, exposure scoring, and reasoning, in accordance with one embodiment of the invention, the embodiment directed to potential misappropriation identification and resolution. As illustrated in block 502, the system initially receives interaction data associated with one or more interactions between an entity (i.e., an entity maintaining the system (e.g., a financial entity)), a client of said entity (e.g., an account holder), and one or more third parties (e.g., merchants). In some embodiments, interaction data is received by the system or submitted to the system through channels including, but not limited to, alerts generated during interaction processing by a processing entity (e.g., a financial entity processing the interaction), requests transmitted by a client or user (i.e., reported potential misappropriation or a request to investigate potential misappropriation), and/or requests submitted by an entity during interaction post-processing (e.g., an entity investigating previously identified misappropriation).

In some embodiments, the system is initially pre-trained with broad spectrum representative data allowing the system to identify one or more data patterns in the data stream and providing a baseline for the system's initial understanding and further learning. In some embodiments, the present system is further configured to assess an incoming data stream in real-time in conjunction with predetermined assessment means (i.e., pre-training and predefined policies). In this way, the system may adapt to changing environmental conditions and learn from a situation dynamically without need to recalibrate the overall system. In some embodiments, the system adapts though iterative processing between a data patterning and exposure scoring process and a reasoning check process as described with respect to FIG. 4. In some embodiments, the system monitors and assesses the incoming data stream. In some embodiments, assessing the data stream may comprise comparing a determined data pattern to a trained data pattern from the predetermined data to identify changes in the data pattern which may require action by the system (e.g., process potential misappropriation). In some embodiments, the system determines data patterns based on the profiles generated by the system from the historical data.

As illustrated in block 504, the system identifies one or more patterns from the interaction data and generates a pattern vector, Pi,j, based on the identified pattern. In some embodiments, the pattern vector, Pi,j, comprises one or more data patterns in the received interaction data based on machine deep learning analysis. In some embodiments, the vector, Pi,j, may comprise one or more identified events, interactions, entities, clients, or the like associated with interaction data. In some embodiments, the system generates custom exposure scores for each of the patterns identified by the pattern learning engine. In some embodiments, exposure scoring may be further calculated based on known misappropriation patterns or strategies and/or other external data.

As illustrated in block 506, the system transmits the pattern vector, Pi,j, to the reasoning engine, wherein the pattern vector is analyzed by the system to identify anomalies. In some embodiments, anomalies in the data pattern may include data that contradicts or is incorrect compared to generated profiles, historical interaction records, and/or an established data pattern. Identified changes may require action by the system or be an indicator of a potential data security threat or misappropriation which may trigger additional action or require a response from the system. The system uses the reasoning engine to analyze the pattern vector based on the data sources available to the reasoning engine as shown and discussed with respect to FIG. 4. The reasoning engine leverages the artificial intelligence of the system to apply logic and identify anomalies of vector Pi,j to confirm, refine, or append the machine learning determined results. In some embodiments, the system analyzes the received data by applying rules and policies for determining authorized interactions from unauthorized interactions (e.g., misappropriation). The rules and policies may be defined by an entity maintaining the system. In one embodiment, an unauthorized interaction may be an interaction not permitted by the rules or policies for reasons other than misappropriation. For example, the rules and policies may define that certain interaction types executed on certain devices are not allowed. In some embodiments, the system analyzes the received data by referencing data ontology information and/or known misappropriation patterns. By applying the various data sources to the received initial machine learning results (i.e., Pi,j), the system leverages the reasoning engine to analyze the results and determine logical inconsistencies in the data patterns of the pattern vector.

As illustrated in block 508, the system generates a reasoning vector, Ri,k, based on the initial deep learning analysis results performed by the pattern learning engine of the system and contained in the pattern vector, Pi,j. The system generates the reasoning vector, Ri,k, based on the performed logical analysis. In some embodiments, as illustrated in block 510, the system transmits the reasoning vector, Ri,k, back to the pattern learning engine.

In one embodiment, the system may confirm the initial machine learning results provided in vector Pi,j, wherein the reasoning vector is the same as the pattern vector. In other embodiments, the reasoning vector, Ri,k, may be a revised vector, wherein the system refines or appends the machine learning determined results. For example, through application of logical reasoning, the reasoning check 420 may remove one or more of the data entries of the initially provided vector. In another embodiment, the system may add additional data entries to the vector thereby producing the revised vector. In some embodiments, the system generates and sends the revised vector back to the pattern learning engine, wherein the revised vector is used as input into the pattern learning engine. By using the revised vector as input, the pattern learning engine may be refined, wherein the artificial intelligence and deep learning engines may learn from the revised input.

In some embodiments, the feedback between the pattern learning engine and the reasoning engine is iterative, wherein the each of the vectors, Pi,j and Ri,k, may be continually revised and sent between pattern learning engine and the reasoning engines until, as illustrated in block 512A, both vectors converge on a conclusion, that is, both vectors include the same one or more results. In another embodiment, the iterative process may continue for a predetermined number of cycles. In another embodiment, the iterative process may continue until a confidence level of the accuracy of the results is above a predetermined threshold and/or an exposure level is below another predetermined threshold.

As illustrated in block 512B, the vectors may not converge on a conclusion. In some embodiments, the system may terminate the patterning the system may terminate the iterative process after a predetermined number of cycles have been completed without converging on a conclusion, a confidence level of the accuracy of the results is below a predetermined threshold, and/or an exposure level is above another predetermined threshold. In one embodiment, upon terminating the system, the system may be further configured to export exposure scoring for the identified patterns without determining a conclusion.

As illustrated in block 514, the system analyzes a final result using an oversight and decisioning engine. In some embodiments, the oversight and decisioning engine is configured to determine a decision on an action to be performed in response to the analysis. In some embodiments, the oversight and decisioning engine may comprise rules and polices determined by the entity maintaining the system for determining a response to the analysis. In some embodiments, the oversight and decisioning engine may determine a response based on the generated profiles (e.g., client loyalty) and user base statistics (e.g., segmentation). Finally, as illustrated in block 516, the system processes the interaction according to a final analysis and decision determined by the system. For example, based on the analysis, the system may decide to process or decline an interaction. In some embodiments, the system determines whether an interaction constitutes misappropriation based on the analysis and how to remedy said misappropriation. In a specific example, the system determines that an interaction associated with a client account is misappropriation based on analyzing the interaction and data patterns using the systems and processes described herein. In response, the system determines to remedy misappropriated resources back to the client based, in part, on the client having a loyalty status of a predetermined level.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with iterative data patterning, exposure scoring, and reasoning.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for iterative data patterning, exposure scoring, and reasoning, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An artificial intelligence system leveraging deep learning technology for data pattern processing and identifying misappropriation, the artificial intelligence system comprising:
a deep learning engine comprising a data patterning component and a reasoning component; and
a controller configured for monitoring interaction data, the controller comprising at least one memory device with computer-readable program code stored thereon, at least one communication device connected to a network, and at least one processing device, wherein the at least one processing device is configured to execute the computer-readable program code to:
monitor a data stream, wherein the data stream comprises interaction data associated with a user;
extract the interaction data associated with the user from the data stream;
determine, using the data patterning component of the deep learning engine, a data pattern from the extracted interaction data, wherein the data pattern is output to the reasoning component of the deep learning engine;
analyze, using the reasoning component, the data pattern by comparing the data pattern to predetermined rules and factual reference data;
identify an anomaly in the data pattern based on comparing the data pattern, wherein the anomaly is associated with potential misappropriation of user resources;
in response to identifying the anomaly, generate a revised data pattern, wherein the revised data pattern is output to the data patterning component; and
confirm the revised data pattern using the data patterning component.

2. The artificial intelligence system of claim 1, wherein the revised data pattern is a first revised pattern, and wherein the at least one processing device is further configured to revise, using the data patterning component, the first revised pattern thereby generating a second revised pattern.

3. The artificial intelligence system of claim 1, wherein the at least one processing device is further configured to execute an iterative revision process, wherein the data patterning component and the reasoning component of the deep learning engine iteratively revise the data pattern.

4. The artificial intelligence system of claim 3, wherein the at least one processing device is further configured to continue the iterative revision process until an output of the data patterning component and an output of the reasoning component converge on a result.

5. The artificial intelligence system of claim 4, wherein the output of the data patterning component and the output of the reasoning component converging on the result comprises the output of the data patterning component and the output of the reasoning component being the same.

6. The artificial intelligence system of claim 4, wherein the output of the data patterning component and the output of the reasoning component converging on the result comprises the controller determining that a similarity between the output of the data patterning component and the output of the reasoning component is within a predetermined threshold.

7. The artificial intelligence system of claim 3, wherein the at least one processing device is further configured to terminate the iterative revision process in response to an output of the data patterning component and an output of the reasoning component not converging on a result.

8. The artificial intelligence system of claim 7, wherein the at least one processing device is further configured to terminate the iterative revision process after a predetermined number of cycles of the iterative revision process, wherein the output of the data patterning component and the output of the reasoning component do not converge during the predetermined number of cycles.

9. The artificial intelligence system of claim 1, wherein the predetermined rules and factual reference data of the reasoning component of the deep learning engine comprise a data ontology database.

10. The artificial intelligence system of claim 1, wherein determining the data pattern from the extracted interaction data using the data patterning component of the deep learning engine further comprises generating a user profile based on historical interaction data.

11. The artificial intelligence system of claim 10, wherein the interaction data comprises at least one interaction between a client and an entity, and wherein generating the user profile based on the historical interaction data further comprises generating a client profile associated with the client and an entity profile associated with the entity.

12. The artificial intelligence system of claim 1 further comprising a data security scoring engine, wherein the at least one processing device is further configured to calculate a data security score for the data pattern, wherein the data security score represents a calculated probability for potential misappropriation associated with the data pattern based on historical interaction data and known misappropriation patterns.

13. A computer-implemented method for iterative data pattern processing leveraging deep learning technology, the computer-implemented method comprising:
providing a deep learning engine comprising a data patterning component and a reasoning component; and
providing a controller configured for monitoring interaction data, the controller comprising at least one memory device with computer-readable program code stored thereon, at least one communication device connected to a network, and at least one processing device, wherein the at least one processing device is configured to execute the computer-readable program code to:
monitor a data stream, wherein the data stream comprises interaction data associated with a user;
extract the interaction data associated with the user from the data stream;
determine, using the data patterning component of the deep learning engine, a data pattern from the extracted interaction data, wherein the data pattern is output to the reasoning component of the deep learning engine;
analyze, using the reasoning component, the data pattern by comparing the data pattern to predetermined rules and factual reference data;
identify an anomaly in the data pattern based on comparing the data pattern, wherein the anomaly is associated with potential misappropriation of user resources;
in response to identifying the anomaly, generate a revised data pattern, wherein the revised data pattern is output to the data patterning component; and
confirm the revised data pattern using the data patterning component.

14. The computer-implemented method of claim 13, wherein the revised data pattern is a first revised pattern, and wherein the computer-implemented method further comprises revising, using the data patterning component, the first revised pattern thereby generating a second revised pattern.

15. The computer-implemented method of claim 13 further comprising executing an iterative revision process, wherein the data patterning component and the reasoning component of the deep learning engine iteratively revise the data pattern.

16. The computer-implemented method of claim 15 further comprising continuing the iterative revision process until an output of the data patterning component and an output of the reasoning component converge on a result.

17. The computer-implemented method of claim 13, wherein the predetermined rules and factual reference data of the reasoning component of the deep learning engine comprise a data ontology database.

18. The computer-implemented method of claim 13, wherein determining the data pattern from the extracted interaction data using the data patterning component of the deep learning engine further comprises generating a user profile based on historical interaction data.

19. The computer-implemented method of claim 13 further comprising providing a data security scoring engine and calculating a data security score for the data pattern, wherein the data security score represents a calculated probability for potential misappropriation associated with the data pattern based on historical interaction data and known misappropriation patterns.

20. An artificial intelligence system leveraging deep learning technology for iterative data pattern processing, the artificial intelligence system comprising:
a deep learning engine comprising a data patterning component and a reasoning component; and
a controller configured for monitoring a data stream, the controller comprising at least one memory device with computer-readable program code stored thereon, at least one communication device connected to a network, and at least one processing device, wherein the at least one processing device is configured to execute the computer-readable program code to:
determine, using the data patterning component of the deep learning engine, a data pattern of the data stream;
analyze, using the reasoning component, the data pattern by comparing the data pattern to predetermined rules and factual reference data;
iteratively revise the data pattern to generate at least one revised data pattern using the data patterning component and the reasoning component, wherein the at least one revised data pattern output from either one of the data patterning component and the reasoning component is subsequently input into the other;
determine that an output of the data patterning component and an output of the reasoning component converge on a final data pattern; and
in response to determining that the output of the data patterning component and the output of the reasoning component converge, confirm the final data pattern.
